(19) United States
(12) Patent Application Publication
(10) Pub. No.: US 2020/0309650 A1
(43) Pub. Date: Oct. 1, 2020

(54) DYEING APPARATUS FOR DETECTING SLIDE

(71) Applicant: Kuo-Lung LOR, New Taipei City (TW)

(72) Inventor: Kuo-Lung LOR, New Taipei City (TW)

(21) Appl. No.: 16/364,213

(22) Filed: Mar. 26, 2019

(51) Int. Cl. G01N 1/31

(52) U.S. Cl. CPC G01N 1/312

(57) ABSTRACT

A dyeing apparatus for detecting slide includes: a motor; a rotary plate, disposed at one end of the motor and having a mounting seat; a buckle seat, disposed in the mounting seat, having the center formed with a penetrated hole and two sides formed with mounting protrusions; a slide frame, disposed above the buckle seat and having the top end formed with a concave recess; a slide, disposed in the concave recess and having the center formed with a convex ring; an absorbing piece, sleeved on the convex ring and having the center formed with a penetrated hole; a bottom seat, disposed above the buckle seat and having two sides formed with lateral edges, wherein the inner side of the lateral edge is formed with ; and a top cover, disposed above the bottom seat and have the inner center formed with a concave part having an inlet hole.

### BACKGROUND OF THE INVENTION

### 1. Field of the Invention

The present invention relates to dyeing apparatus, especially to a dyeing apparatus for detecting slide, in which a mounting seat at the top end of a rotary plate is sequentially disposed with a buckle seat, a slide frame, a slide, an absorbing piece, a bottom seat and a top cover, a motor is served to drive to rotate for generating a centrifugal force, and the absorbing piece is served to absorb the wastes of dyeing agents used for dyeing a specimen.

### 2. Description of Related Art

N/A

### SUMMARY OF THE INVENTION

One primary objective of the present invention is to a dyeing apparatus for detecting slide, in which a mounting seat at the top end of a rotary plate is sequentially disposed with a buckle seat, a slide frame, a slide, an absorbing piece, a bottom seat and a top cover, a motor is served to drive to rotate for generating a centrifugal force, and the absorbing piece is served to absorb the wastes of dyeing agents used for dyeing a specimen, thereby overcoming the shortages existed in prior art.

Another objective of the present invention is to a dyeing apparatus for detecting slide, wherein a single specimen is able to be detected in a single manner, and the wastes of dyeing agents used for dyeing the specimen can be prevented from leaking.

One another objective of the present invention is to a dyeing apparatus for detecting slide, wherein advantages of effectively improving the operation convenience and operation time are provided.

Accordingly, the present invention provides a dyeing apparatus for detecting slide, in which a specimen being dyed by dyeing agents of a plurality of dyeing agent spraying devices for observing the dyeing contacting of the specimen and the environment, and including:

a motor, wherein one end of the motor is disposed with a rotation shaft for providing power;

a rotary plate, disposed at one end of the motor, wherein the top end of the rotary plate is disposed with a mounting seat, the bottom end thereof is disposed with a shaft seat, and the center of the shaft seat is formed with an insertion hole corresponding to the rotation shaft of the motor;

a buckle seat, disposed in the mounting seat of the rotary plate, wherein the center of the buckle seat is formed with a penetrated hole and two sides and four corners thereof are respectively formed with mounting protrusions and positioning recesses;

a slide frame, disposed above the buckle seat, wherein the top end of the slide frame is formed with a concave recess, and two sides thereof are respectively formed with a lateral recess, and lower four corners of the slide frame are respectively formed with a positioning protrusion corresponding to the positioning recesses of the buckle seat;

a slide, disposed in the concave recess of the slide frame, wherein the center of the slide is formed with a convex ring;

an absorbing piece, sleeved on the convex ring of the slide, wherein the center of the absorbing piece is formed with a penetrated hole corresponding to the outer side of the convex ring of the slide;

a bottom seat, disposed above the buckle seat and having two sides thereof formed with lateral edges crossing the two sides of the buckle seat, wherein the inner side of the lateral edge is formed with mounting recesses corresponding to the mounting protrusions of the buckle seat, the center of the bottom seat is formed with a penetrated hole having the corresponding shape relative to the absorbing piece for fastening the outer periphery of the absorbing piece, and four corners of the bottom seat are formed with positioning recesses; and

a top cover, disposed above the bottom seat, wherein the inner center thereof is formed with a concave part corresponding to the penetrated hole of the bottom seat, the center of the concave part is thoroughly formed with an inlet hole for allowing dyeing agents to be provided, and lower four corners of the top cover are formed with positioning protrusions corresponding to the positioning recesses of the bottom seat.

Furthermore, according to the present invention, two sides of the mounting seat of the rotary plate are respectively formed with an outwardly expandable part allowing at least one finger to apply an external force.

Preferably, according to the present invention, the convex ring of the slide is formed in a circular status.

Preferably, according to the present invention, the top end of the slide frame and the top end of the slide disposed in the concave recess are arranged on the same plane.

Preferably, according to the present invention, the absorbing piece is formed in a circular status.

Preferably, according to the present invention, the material of the absorbing piece is a sponge or paper cottons.

Comparing to prior art, the present invention utilizes the mounting seat at the top end of the rotary plate being sequentially disposed with the buckle seat, the slide frame, the slide, the absorbing piece, the bottom seat and the top cover, the motor being served to drive to rotate for generating the centrifugal force, and the absorbing piece being served to absorb the wastes of the dyeing agents used for dyeing the specimen, so that the single specimen is able to be detected in a single manner, and the wastes of the dyeing agents used for dyeing the specimen can be prevented from leaking, thus the present invention is provided with advantages of effectively improving the operation convenience and operation time. Accordingly, the dyeing apparatus for detecting slide provided by the present invention is novel and more practical in use compared to the prior art.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective exploded view according to the present invention;

FIG. 2 is a perspective view showing the assembly according to the present invention;

FIG. 3 is a cross sectional view showing the assembly according to the present invention; and

FIG. 4 is a schematic view showing the dyeing apparatus for detecting slide and plural dyeing agent spraying devices having dyeing agents being rotated for generated a centrifugal force and enabling the wastes of the dyeing agents to be absorbed according to one preferred embodiment of the present invention.

### DETAILED DESCRIPTION OF THE PREFERRED EMBODIMENT

One preferred embodiment of the present invention will be described with reference to the drawings.

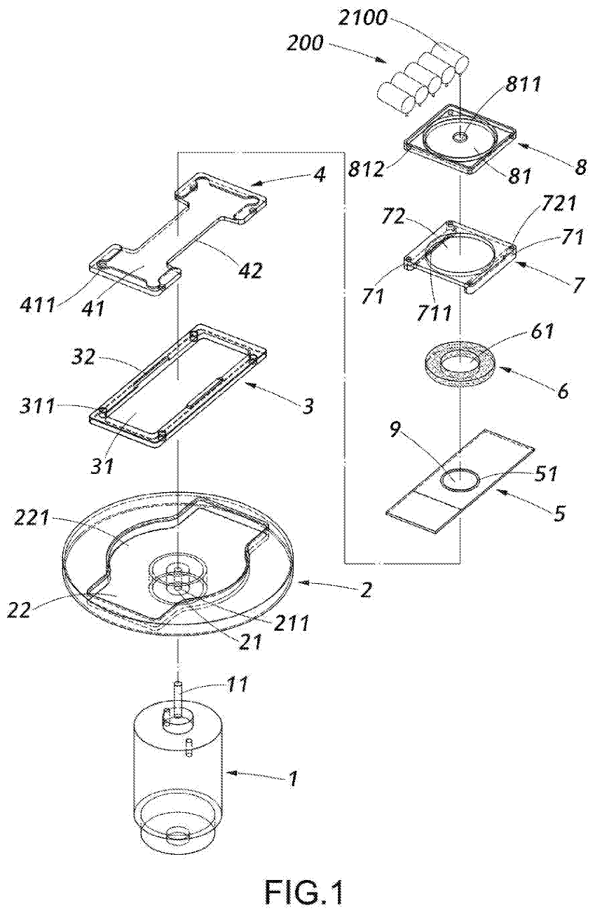

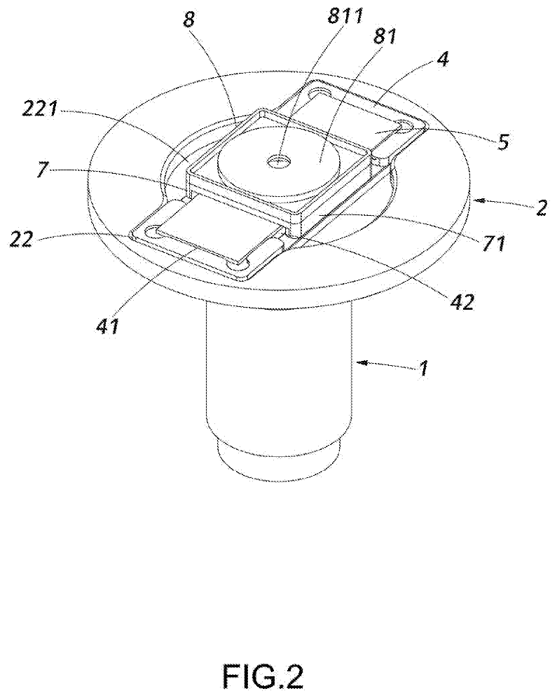

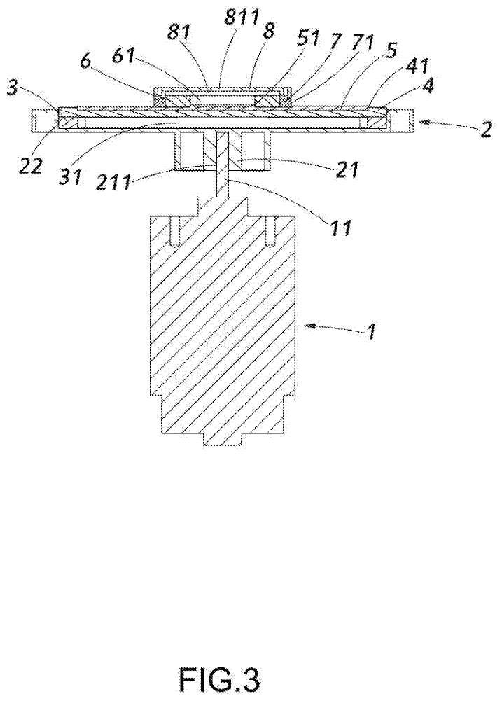

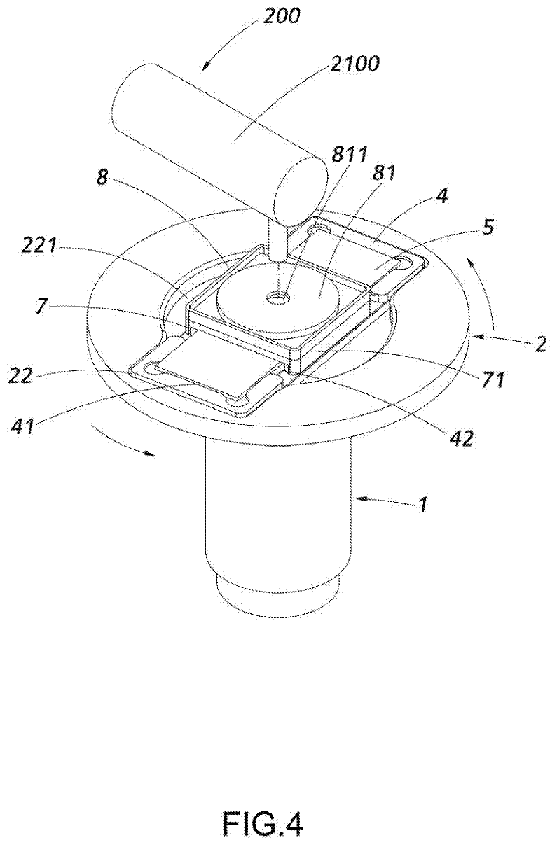

Referring from FIG. 1 to FIG. 4, wherein FIG. 1 is a perspective exploded view according to the present invention; FIG. 2 is a perspective view showing the assembly according to the present invention; FIG. 3 is a cross sectional view showing the assembly according to the present invention; and FIG. 4 is a schematic view showing the dyeing apparatus for detecting slide and plural dyeing agent spraying devices having dyeing agents being rotated for generated a centrifugal force and enabling the wastes of the dyeing agents to be absorbed according to one preferred embodiment of the present invention. According to one preferred embodiment, the present invention provides a dyeing apparatus for detecting slide, in which a specimen 9 is dyed by dyeing agents 2100 of a plurality of dyeing agent spraying devices 200 for observing the dyeing contacting of the specimen 9 and the environment, wherein the specimen 9 can be germs; the dyeing apparatus for detecting slide includes: a motor 1, a rotary plate 2, a buckle seat 3, a slide frame 4, a slide 5, an absorbing piece 6, a bottom seat 7 and a top cover 8.

One end of the motor 1 is disposed with a rotation shaft 11 for providing power.

The rotary plate 2 is disposed at one end of the motor 1, the top end of the rotary plate 2 is disposed with a mounting seat 22, the bottom end thereof is disposed with a shaft seat 21, the center of the shaft seat 21 is formed with an insertion hole 211 corresponding to the rotation shaft 11 of the motor 1, and two sides of the mounting seat 22 of the rotary plate 2 are respectively formed with an outwardly expandable part 221 allowing at least one finger to apply an external force.

The buckle seat 3 is disposed in the mounting seat 22 of the rotary plate 2, the center of the buckle seat 3 is formed with a penetrated hole 31 and two sides and four corners thereof are respectively formed with mounting protrusions 32 and positioning recesses 311.

The slide frame 4 is disposed above the buckle seat 3, the top end of the slide frame 4 is formed with a concave recess 41, and two sides thereof are respectively formed with a lateral recess 42, and lower four corners of the slide frame 4 are respectively formed with a positioning protrusion 411 corresponding to the positioning recesses 311 of the buckle seat 3.

The slide 5 is disposed in the concave recess 41 of the slide frame 4, the center of the slide 5 is formed with a convex ring 51, according to this embodiment, the convex ring 51 is formed in a circular status, but what shall be addressed is that the scope of the present invention is not limited to the above-mentioned circular status, other geometric statuses are all within the scope of the present invention, and the top end of the slide frame 4 and the top end of the slide 5 disposed in the concave recess 41 are arranged on the same plane.

The absorbing piece 6 is sleeved on the convex ring 51 of the slide 5, the center of the absorbing piece 6 is formed with a penetrated hole 61 corresponding to the outer side of the convex ring 51 of the slide 5, according to this embodiment, the absorbing piece 6 is formed in a circular status, but what shall be addressed is that the scope of the present invention is not limited to the above-mentioned circular status, other geometric statuses are all within the scope of the present invention, and according to this embodiment, the material of the absorbing piece 6 is an absorbing material such as a sponge or paper cottons, but what shall be addressed is that the scope of the present invention is not limited to the above-mentioned absorbing material such as the sponge or the paper cottons, other materials having absorbing function are all within the scope of the present invention.

The bottom seat 7 is disposed above the buckle seat 3, and two sides thereof are formed with lateral edges 71 crossing the two sides of the buckle seat 3, the inner side of the lateral edge 71 is formed with mounting recesses 711 corresponding to the mounting protrusions 32 of the buckle seat 3, the center of the bottom seat 7 is formed with a penetrated hole 72 having the corresponding shape relative to the absorbing piece 6 for fastening the outer periphery of the absorbing piece 6; and four corners of the bottom seat 7 are additionally formed with positioning recesses 721.

The top cover 8 is disposed above the bottom seat 7, lower four corners thereof are formed with positioning protrusions 812 corresponding to the positioning recesses 721 of the bottom seat 7, the inner center thereof is formed with a concave part 81 corresponding to the penetrated hole 72 of the bottom seat 7, and the center of the concave part 81 is thoroughly formed with an inlet hole 811 for allowing the dyeing agents 2100 to be provided.

When the present invention is in use, the single specimen 9 is disposed in the interior of the convex ring 51 of the slide 5, the motor 1 is served to drive the rotary plate 2 and the slide 5 disposed thereon to rotate, the inlet hole 811 of the top cover 8 allows the different dyeing agents 2100 of the plural dyeing agent spraying devices 200 to be respectively sprayed in, and a centrifugal force generated by the rotations of the motor 1 enables the specimen 9 having the cell walls being dyed and the wastes of the dyeing agents 2100 to be spun out so as to be absorbed by the absorbing piece 6 disposed on the convex ring 51 (as shown in FIG. 4).

Accordingly, the present invention utilizes the mounting seat 22 at the top end of the rotary plate 2 being sequentially disposed with the buckle seat 3, the slide frame 4, the slide 5, the absorbing piece 6, the bottom seat 7 and the top cover 8, the motor 1 being served to drive to rotate for generating the centrifugal force, and the absorbing piece 6 being served to absorb the wastes of the dyeing agents 2100 used for dyeing the specimen 9, so that the single specimen 9 is able to be detected in a single manner, and the wastes of the dyeing agents 2100 used for dyeing the specimen 9 can be prevented from leaking, thus the present invention is provided with advantages of effectively improving the operation convenience and operation time. Accordingly, the dyeing apparatus for detecting slide provided by the present invention is novel and more practical in use compared to the prior art.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. A dyeing apparatus for detecting slide, in which a specimen being dyed by dyeing agents of a plurality of dyeing agent spraying devices for observing the dyeing contacting of the specimen and the environment, and including: including:
a motor, wherein one end of the motor is disposed with a rotation shaft for providing power;
a rotary plate, disposed at one end of the motor, wherein the top end of the rotary plate is disposed with a mounting seat, the bottom end thereof is disposed with a shaft seat, and the center of the shaft seat is formed with an insertion hole corresponding to the rotation shaft of the motor;
a buckle seat, disposed in the mounting seat of the rotary plate, wherein the center of the buckle seat is formed with a penetrated hole and two sides and four corners thereof are respectively formed with mounting protrusions and positioning recesses;
a slide frame, disposed above the buckle seat, wherein the top end of the slide frame is formed with a concave recess, and two sides thereof are respectively formed with a lateral recess, and lower four corners of the slide frame are respectively formed with a positioning protrusion corresponding to the positioning recesses of the buckle seat;
a slide, disposed in the concave recess of the slide frame, wherein the center of the slide is formed with a convex ring;
an absorbing piece, sleeved on the convex ring of the slide, wherein the center of the absorbing piece is formed with a penetrated hole corresponding to the outer side of the convex ring of the slide;
a bottom seat, disposed above the buckle seat and having two sides thereof formed with lateral edges crossing the two sides of the buckle seat, wherein the inner side of the lateral edge is formed with mounting recesses corresponding to the mounting protrusions of the buckle seat, the center of the bottom seat is formed with a penetrated hole having the corresponding shape relative to the absorbing piece for fastening the outer periphery of the absorbing piece, and four corners of the bottom seat are formed with positioning recesses; and
a top cover, disposed above the bottom seat, wherein the inner center thereof is formed with a concave part corresponding to the penetrated hole of the bottom seat, the center of the concave part is thoroughly formed with an inlet hole for allowing dyeing agents to be provided, and lower four corners of the top cover are formed with positioning protrusions corresponding to the positioning recesses of the bottom seat.

2. The dyeing apparatus for detecting slide as claimed in claim 1, wherein two sides of the mounting seat of the rotary plate are respectively formed with an outwardly expandable part allowing at least one finger to apply an external force.

3. The dyeing apparatus for detecting slide as claimed in claim 1, wherein the convex ring of the slide is formed in a circular status.

4. The dyeing apparatus for detecting slide as claimed in claim 1 , wherein the top end of the slide frame and the top end of the slide disposed in the concave recess are arranged on the same plane.

5. The dyeing apparatus for detecting slide as claimed in claim 3, wherein the absorbing piece is formed in a circular status.

6. The dyeing apparatus for detecting slide as claimed in claim 1, wherein the material of the absorbing piece is a sponge or paper cottons.
